(19) United States
(12) Patent Application Publication
(10) Pub. No.: US 2009/0207782 A1
(43) Pub. Date: Aug. 20, 2009

(54) AGGREGATION MANAGEMENT SYSTEM, AGGREGATE NODE, AND DEAGGREGATE NODE

(75) Inventors: Hong Cheng, Singapore (SG); Pek Yew Tan, Singapore (SG); Takako Hori, Kanagawa (JP); Toyoki Ue, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/089,032

(22) PCT Filed: Oct. 10, 2006
(86) PCT No.: PCT/JP2006/320518

§ 371 Date: Apr. 30, 2008

(30) Foreign Application Priority Data
Oct. 7, 2005 (JP) 2005-295549

(51) Int. Cl. H04W 8/00

(52) U.S. Cl. 370/328

(57) ABSTRACT

A technology for providing an aggregation management system and the like which can quickly and efficiently manage aggregation in a mobile-environment is disclosed. According to the technology, an aggregate node adds mobile status information to signaling messages of end-to-end signaling sessions received from mobile terminals 101 to 105, and sends the signaling messages added with the mobile status information to a deaggregate node 117 in new aggregated sessions where the aggregate node is shifted. The deaggregate node in the new aggregated sessions where the aggregate node is shifted (or relay nodes 131 to 135 as a crossover node) which receives the signaling messages added with the mobile status information, based on the mobile status information, release aggregated sessions before the aggregate node is shifted, or sends a message to release the aggregated sessions to a deaggregate node 113 before the aggregate node is shifted.

### TECHNICAL FIELD

The present invention relates to a data communication network, and particularly relates to an aggregation management system, an aggregate node, and a deaggregate node which perform signalings in a packet based on a data communication system having aggregated sessions and resource management.

### BACKGROUND ART

In mobile communication networks, tunneling technology is widely used, for example, between a mobile terminal and an external communication other party or a home agent. In general, in such a tunneling, data traffics of different sessions are aggregated. When the data traffics are aggregated in path coupled signalings such as RSVP (refer to the following non-patent document 1) and NSIS (Next Step In Signaling) (refer to the following non-patent document 2), the signalings such as signalings for QoS (Quality of Service) resource reservation are aggregated as well. When the signalings are aggregated, it is necessary to perform appropriate session management in an aggregated section.

One of the main issues in the signaling aggregation is to assure that each relevant flow is appropriately treated on the aggregated section. In almost all cases, nodes at the both ends of aggregation (aggregator (called aggregate node as well) and deaggregator (called deaggregate node)) are signaling aware nodes (nodes capable of processing signalings). As described in the following non-patent document 3, the aggregator modifies path finding messages so that end-to-end signaling messages skip an internal node in the aggregation and directly proceed to the deaggregator. In the aggregated section, another session is assigned to signaling management.

In such a management method, the amount of accumulated states and signaling messages to be converted in the aggregation region are decreased. However, such method results in problems in mobility support.

For explaining the problems, FIG. 1 shows an example of a mobility scenario including aggregation. As shown in FIG. 1, signaling nodes (SN) 101 to 105 have signaling sessions respectively in relation to end nodes (EN) 141 to 145 as nodes in other group. The numbers of SN, EN, and CRN are not limited to the numbers of FIG. 1, but may be any given number (k, m, and n are given natural numbers). The signaling sessions pass a domain 120, and are set with the aggregation. The aggregation has an aggregator 111 for aggregating the sessions and a deaggregator 113 for deaggregating the sessions. In this case, for example, the end-to-end signaling session from the signaling node 101 to the corresponding end node 141 passes over any internal node in the domain 120. These sessions can be seen only by a network element after the deaggregator 113 such as a crossover node (CRN) 131. In the domain 120, that is, in between the aggregator 111 and the deaggregator 113, another session is used for providing aggregated control for these end-to-end sessions.

When the aggregator 111 is shifted to, for example, a position of an aggregator 115 of a domain 122, all the signaling nodes 101 to 105 are shifted to the new domain together with the aggregator 111. This occurs, for example, in the case that the aggregator 111 is an access router of a mobile network or a personal area network. In such a case, a deaggregation point is also shifted, for example, to a deaggregator 117. In the new positions, the same signaling procedure is executed. Therefore, the aggregated sessions are restructured between the new deaggregator 117 and the new aggregator 115.

Patent document 1: US2004/0260796 A1 “Method and arrangement in an ip network”

Patent document 2: U.S. Pat. No. 6,069,889 A “Aggregation of data flows on switched network paths”

Non-patent document 1: R. Braden, et al. “Resource ReSerVation Protocol (RSVP)”, RFC 2205, September 1997

Non-patent document 2: IFTF Next Step In Signaling (NSIS) (http://www.ietf.org/html.charters/nsis-charter.h tml)

Non-patent document 3: F. Baker, et al. “Aggregation of RSVP for IPv4 IPv6 Reservations”, RFC 3175 Non-patent document 4: H. Cheng, et al. “NSIS Flow ID and Packet Classification Issues”, draft-cheng-nsis-flowid-issues-01.txt (work in progress), July 2005

If a crossover node exists between the new aggregated sessions in the domain 122 and the old aggregated sessions in the domain 120, the old aggregated sessions in the domain 120 can be released from the crossover node. However, in the case as shown in FIG. 1, no crossover node exists between the new aggregated sessions in the domain 122 and the old aggregated sessions in the domain 120. Therefore, for example, when a signaling is intended for QoS resource reservation, it is not possible to appropriately release the reservation used in the old aggregated sessions in the domain 120. As above, a resource reserved in the domain 120 for the old aggregated sessions remains wasted. When the aggregated sessions use soft state management for the reservation, the state in the old aggregation is torn only after timeout. Such a method is not accepted by network management, particularly by management of an access network with limited resources.

There is another problem. That is, shift or change of the position of the aggregator is not visible to the end nodes of the communications. For example, when the end nodes (for example, the signaling nodes 101 to 105) are in a mobile network and the aggregator 111 is a mobile router, the end nodes are not able to see that the aggregator is shifted from the position 111 to the position 115. This means that a signaling state on a new path from the deaggregator 117 to a different crossover node is not able to be structured instantly. In general, this means interruption in the QoS for a communication session.

In some inventions (refer to the foregoing patent documents 1 and 2), aggregation problems in communication networks have been tried to be resolved. However, the solutions thereof concentrate on data flow aggregation and management thereof. Therefore, the foregoing inventions do not address the problem of changing aggregation points.

The foregoing non-patent document 2 defines some procedures of finding a crossover node. However, as described above, the new aggregated sessions and the old aggregated sessions may have no common node. Therefore, there is no crossover node identifiable in the aggregated sessions. In such a case, tearing the aggregated sessions depends on path management of each end-to-end session. For example, when all crossover nodes (for example, crossover nodes 131 to 135) or end nodes send TEAR messages are sent to all the respective end-to-end sessions, an old deaggregation point, for example, the deaggregator 113 can presume that the old aggregated sessions would be torn. Such a kind of processing is slow and is not reliable. For example, when one of the TEAR messages does not reach the deaggregator 113, the old session is not removed indefinitely.

### DISCLOSURE OF THE INVENTION

In order to solve the above problems, it is an object of the invention to provide an aggregation management system and the like which can quickly and efficiently manage aggregation particularly in a mobile environment.

It is another object of the invention to provide a means for efficiently managing end-to-end sessions when an aggregated section is changed.

As a broad aspect, the invention provides a system for controlling and managing signalings in a data communication network having an aggregator and a deaggregator. The aggregator can be a mobile, and can aggregate one or more end-to-end signaling sessions passing the aggregator and the deaggregator in aggregated sessions. The aggregator can add an information element (mobile status information) to signaling messages received in the one or more end-to-end signaling sessions. The information element can indicate the mobile status of the aggregator.

As a preferable aspect, the information element is composed of information indicating shift of the aggregator, information on the aggregated sessions before the aggregator is shifted, and information on desirable dealing (entreatment) in the aggregated sessions before the aggregator is shifted.

As another aspect, a crossover node sends update (TEAR) messages onto the signaling sessions before the aggregator is shifted including the foregoing information element, so that the initial deaggregator can process the old aggregated sessions as appropriate.

To attain the foregoing objects, according to the invention, there is provided an aggregation management system in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node, wherein after the aggregate node is shifted from the region of the aggregated sessions, the aggregate node adds mobile status information indicating its mobile status to a signaling message in the end-to-end signaling session received from the mobile terminal, and sends the signaling message added with the mobile status information to a deaggregate node in new aggregated sessions where the aggregate node is shifted, the deaggregate node in the new aggregated sessions where the aggregate node is shifted (or the relay node as a crossover node which is a branch point between old and new paths) which receives the signaling message added with the mobile status information, based on the mobile status information, releases the aggregated sessions before the aggregate node is shifted or sends a message to release the aggregated sessions before the aggregate node is shifted to the deaggregate node before the aggregate node is shifted. By such a structure, aggregation can be quickly and efficiently managed.

Further, according to a preferable aspect of the invention, in the aggregation management system of the invention, the mobile status information is composed of information indicating that the aggregated node is shifted and information on the aggregated sessions before the aggregate node is shifted. By such a structure, the initial deaggregator can process the old aggregated sessions as appropriate.

Further, according to a preferable aspect of the invention, in the aggregation management system of the invention, the mobile status information further includes information on the deaggregate node in the aggregated sessions before the aggregate node is shifted. By such a structure, the old aggregated sessions can be processed as appropriate.

Further, according to a preferable aspect of the invention, in the aggregation management system of the invention, the mobile status information further includes information on dealing with the aggregated sessions before the aggregate node is shifted. By such a structure, the old aggregated sessions can be processed as appropriate.

Further, according to a preferable aspect of the invention, in the aggregation management system of the invention, the aggregate node retains an aggregation relationship table indicating a relationship between the one or more end-to-end signaling sessions and the aggregated sessions. By such a structure, the old aggregated sessions can be processed as appropriate.

Further, according to a preferable aspect of the invention, in the aggregation management system of the invention, the aggregate node further includes a means for recognizing a relation between its shift and receiving signaling messages in the one or more end-to-end signaling sessions. By such a structure, the old aggregated sessions can be surely processed after the aggregate node is shifted.

Further, according to a preferable aspect of the invention, in the aggregation management system of the invention, the relay node receiving the signaling message with the mobile status information adds information on dealing of the aggregated sessions before the aggregate node is shifted to the message for releasing the aggregated sessions before the aggregate node is shifted which is sent when the relay node is the crossover node based on the mobile status information. By such a structure, the old aggregated sessions can be processed as appropriate.

Further, according to a preferable aspect of the invention, in the aggregation management system of the invention, the deaggregate node in the aggregated sessions before the aggregate node is shifted releases the aggregated sessions before the aggregate node is shifted based on the message for releasing the aggregated sessions before the aggregate node is shifted. By such a structure, the old aggregated sessions can be efficiently processed.

Further, according to a preferable aspect of the invention, in the aggregation management system of the invention, the aggregate node is one of ends of the one or more end-to-end signaling sessions. By such a structure, the old aggregated sessions can be efficiently processed.

Further, according to a preferable aspect of the invention, in the aggregation management system of the invention, the aggregate node is a mobile router in a mobile network. By such a structure, aggregation can be quickly and efficiently managed in a mobile environment.

Further, according to a preferable aspect of the invention, in the aggregation management system of the invention, the aggregate node is one node in a personal area network. By such a structure, aggregation can be efficiently managed.

Further, according to a preferable aspect of the invention, in the aggregation management system of the invention, the aggregate node notifies its shift to end nodes of the one or more end-to-end signaling sessions. By such a structure, the end-to-end session can be efficiently managed.

Further, according to a preferable aspect of the invention, in the aggregation management system of the invention, the aggregate node resends one or more of the signaling messages in the one or more end-to-end signaling sessions which are received before its shift. By such a structure, the procedure can be started without waiting next signaling messages.

Further, according to the invention, there is provided the aggregate node in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node, including an aggregation control means for performing session aggregation, an aggregation relationship table for storing information on the one or more end-to-end signaling sessions and the aggregated sessions, a signaling management means for processing and transmitting a received end-to-end signaling message and a signaling message of the aggregated sessions, and a mobility management means for maintaining a trace of an aggregate node status, updating the aggregation relationship table, and sending a trigger to the signaling management means. By such a structure, aggregation can be quickly and efficiently managed.

Further, according to the invention, there is provided the deaggregate node in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node, including a deaggregation control means for performing session deaggregation, an aggregation relation table for storing information on the one or more end-to-end signaling sessions and the aggregated sessions, and a signaling management means for processing and transmitting a received end-to-end signaling message and a signaling message of the aggregated sessions, wherein the signaling management means updates the aggregation relationship table according to the received signaling message, and the deaggregation control means performs session deaggregation according to the information stored in the aggregation relationship table. By such a structure, aggregation can be quickly and efficiently managed.

The aggregation management system, the aggregate node, and the deaggregate node of the invention have the foregoing structures, and can quickly and efficiently manage aggregation in a mobile environment.

### BRIEF DESCRIPTION OF THE DRAWINGS

FIG. 1 is a model diagram showing an example of a network structure of an aggregation management system according to an embodiment of the invention;

FIG. 2 is a sequence chart showing an example of an operation sequence for accurately and quickly updating old aggregated sessions in the aggregation management system according to the embodiment of the invention;

FIG. 3 is a flow chart showing an example of a processing flow by an aggregator in the aggregation management system according to the embodiment of the invention;

FIG. 4 is a flow chart showing an example of a processing flow by a deaggregator in the aggregation management system according to the embodiment of the invention;

FIG. 5 is a structural diagram showing an example of a structure of the aggregator in the aggregation management system according to the embodiment of the invention; and

FIG. 6 is a structural diagram showing an example of a structure of the deaggregator in the aggregation management system according to the embodiment of the invention.

### BEST MODE FOR CARRYING OUT THE INVENTION

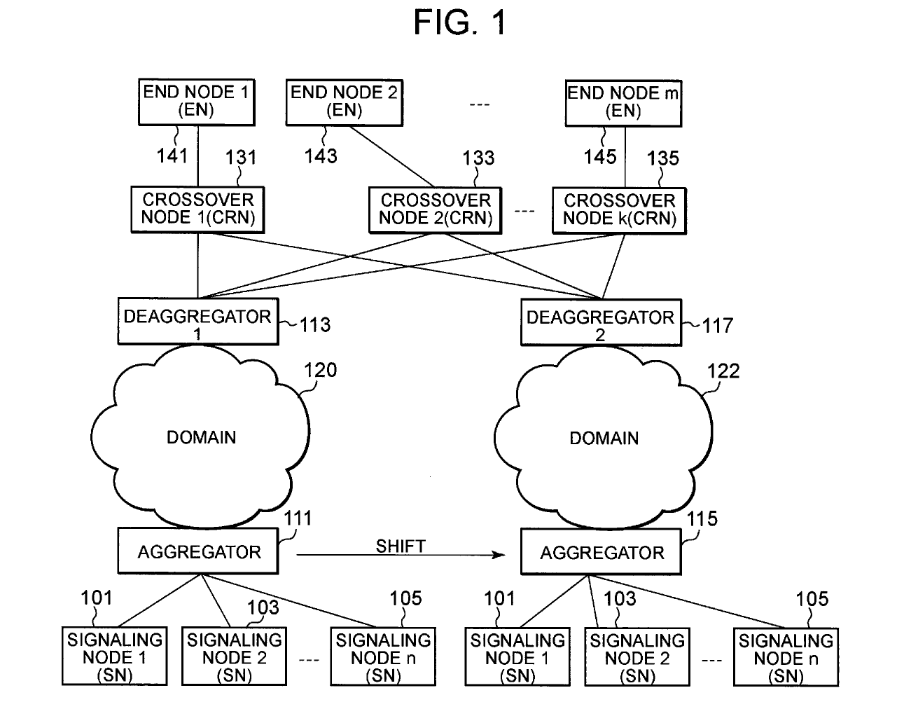

A description will be hereinafter given of an aggregation management system, an aggregate node, and a deaggregate node according to an embodiment of the invention with reference to FIG. 1 to FIG. 6. FIG. 1 shows an example of a network structure in which the invention is developed. FIG. 1 shows only necessary network elements related to processing. As will be understood by those skilled in the art, the network can include more complicated structures which do not affect rightness of the invention. For example, the network may further include a node which can process signalings between the deaggregator 113 and the end node 141. k, m, and n used in FIG. 1 are given numbers for explaining the embodiment of the invention. As will be understood by those skilled in the art, actual numerical values do not affect efficient operations of the invention. It is presumed that the signaling used for explaining the embodiment is related to QoS resource reservation, release thereof, management thereof and the like such as NSIS QoS signaling messages. Further, FIG. 1 shows an aggregator and a signaling node as separate nodes. However, the aggregator may have a function of the signaling node. For example, the aggregator 111 (or aggregator 115) and the signaling nodes 101 to 105 may be structured as one node.

As shown in FIG. 1, an end-to-end signaling end node group (signaling nodes 101 to 105) is shifted together with the aggregator 111 which is shifted from the position of the domain 120 to the position of the domain 122. This is equal to in the case of a mobile network having an access router changing addresses. Such a shift is not visible to internal nodes of the mobile network.

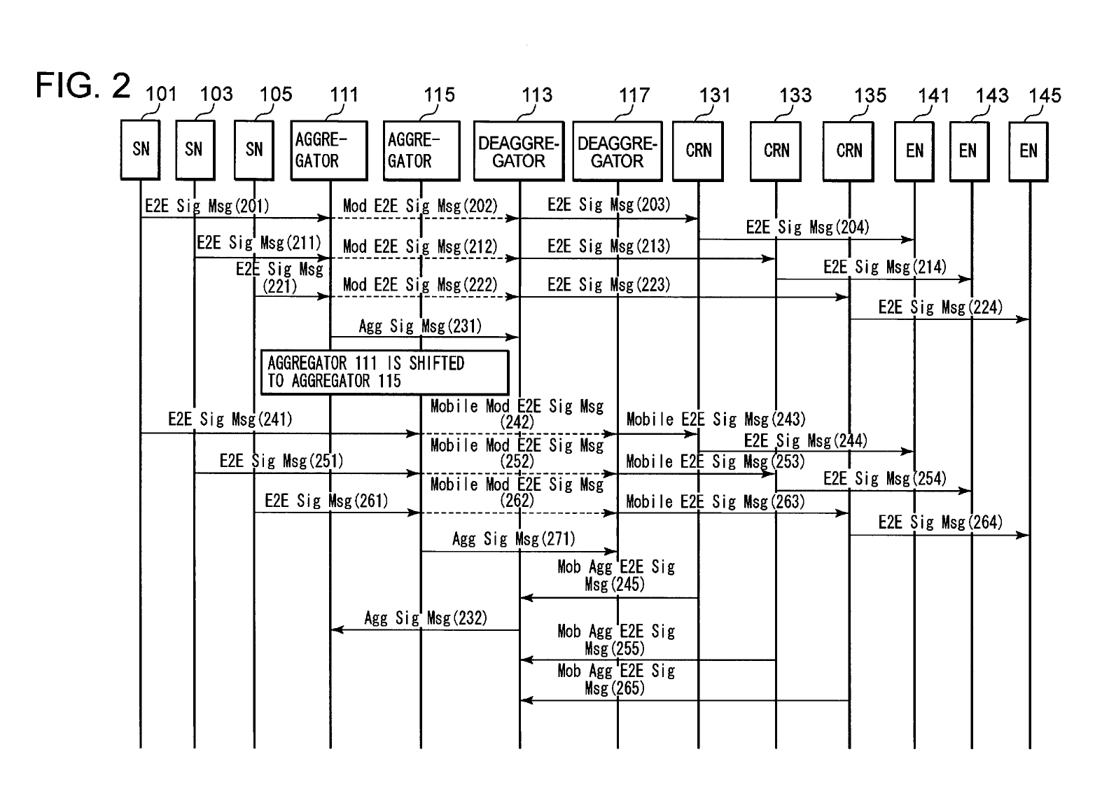

With reference to FIG. 2, a description will be given of an example of an operation sequence in the invention in which old aggregated sessions can be accurately and quickly updated. As shown in FIG. 2, the end-to-end signaling nodes (for example, the signaling nodes 101 to 105) respectively send end-to-end signaling messages (E2E Sig Msg) 201, 211, 221 to corresponding end nodes (for example, end nodes 141 to 145) via the aggregator 111.

Aggregation is applied between the aggregator 111 and the deaggregator 113. The aggregation is based on, for example, a tunneling between the two nodes. To aggregate the end-to-end signaling sessions, the aggregator 111 should modify the end-to-end messages so that a direct signaling path is formed between the aggregator 111 and the deaggregator 113 (for example, setup in which the end-to-end messages are not processed by an internal node of the domain 120).

Modifying the end-to-end messages can be attained by using a different method depending on an actual signaling scheme and an execution thereof. For example, as described in the non-patent document 3, when the end-to-end signalings use RSVP, modifying the end-to-end messages is attained by modifying an IP protocol number of a PATH message. As will be understood by those skilled in the art, for example, it is possible to utilize a method to encapsulate the end-to-end signaling messages or provide tunneling for the end-to-end signaling messages directly from the aggregator 111 to the deaggregator 113 without affecting the principles of the invention.

As shown in FIG. 2, modified end-to-end signaling messages (Mod E2E Sig Msg) 202, 212, 222 pass the domain 120 without being processed. When the messages reach the deaggregator 113, the messages 202, 212, 222 are returned to each original (initial) type as appropriate. For example, each IP protocol number in each RSVP message is returned to each corresponding value. Then, the messages respectively flow along each path corresponding to each destination as E2E Sig Msg 203, 213, 223. In result, signaling states are accurately set up along the paths.

Concurrently, for example, when the E2E Sig Msg is a signaling for QoS resource reservation, the aggregator 111 generates the aggregated sessions according to the end-to-end signaling messages so that corresponding network (QoS) resources can be reserved for all the aggregated sessions in the domain 120. Such aggregated sessions are generated by an aggregated signaling message (Agg Sig Msg) 231 of FIG. 2.

In the aggregator 111 and the deaggregator 113, a relation between each end-to-end session and the aggregated sessions are recorded. For example, the aggregator 111 and the deaggregator 113 can respectively maintain an aggregation relationship table (ART) database. The ART has an aggregated sessions ID as a primary (initial) key. Each ART entry (registration) includes all individual end-to-end session IDs. For example, an entry format is as follows.

ART Entry:=<Aggregated sessions ID>,
<The number of included E2E sessions>,
[Each E2E session ID]

As will be understood by those skilled in the art, there is another method to accumulate information without affecting operations of the invention. The ART in the deaggregator 113 is structured by the deaggregator 113 itself. Otherwise, the ART of the deaggregator 113 is obtained from the Agg Sig Msg 231.

As shown in FIG. 2, at a certain point, the position of the aggregator 111 is shifted to the position of the aggregator 115 in the domain 122. To indicate that the position of the aggregator in specific aggregated sessions is changed, the aggregator 115 includes an indicator in the ART. An entry example of the ART is as follows:

ART Entry:=<Aggregated sessions information>,
<The number of included E2E sessions>, [Each E2E session entry:=<E2E session information>,
   <mobility indicator (shift indicator)>]

Therefore, when the aggregator 115 is shifted, the aggregator 115 sets all the mobility indicators in the current ART. As will be understood by those skilled in the art, there are other methods to indicate such information. Further, the invention can be processed by using these methods.

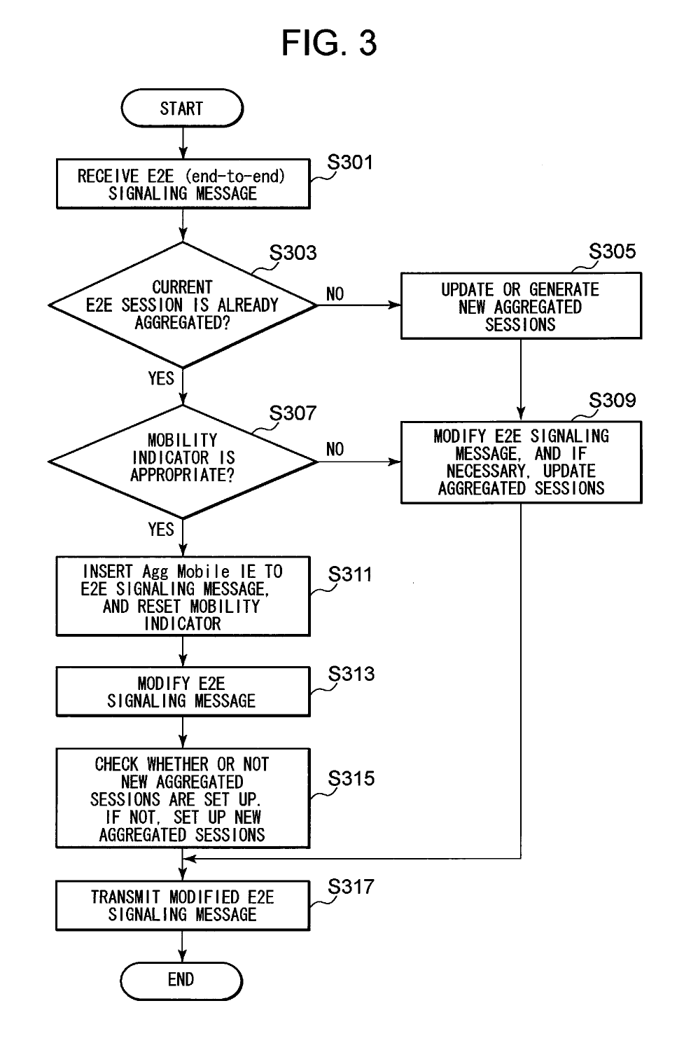

After that, when the aggregator 115 further receives an end-to end signaling message (E2E Sig Msg 241), the aggregator 115 checks the message in comparison with the ART and processes the message accordingly. FIG. 3 shows an example of the processing by the aggregator 115. As shown in step 301, when an end-to-end signaling message is received, the aggregator 115 checks the ART. As in step 303, the aggregator 115 checks whether or not a current end-to-end session is already aggregated. When the end-to-end session belongs to specific aggregated sessions, as in step 307, the aggregator 115 checks whether or not a mobility indicator of a corresponding ART entry is appropriate (correct).

When an appropriate value of the mobility indicator is detected, as show in step 311, the aggregator 115 inserts an aggregation mobile information element (Agg Mobile IE) to the end-to-end signaling message. The Agg Mobile IE is composed of items indicating the shift of the aggregator 115 and information on the previous aggregated sessions when the aggregator 115 is located in the domain 120. An example of the Agg Mobile IE is shown as follow.
Agg Mobile IE:=<Aggregator mobile indicator>,
   <Previous aggregated sessions ID>,
   <Previous deaggregator ID>
   <Desirable processing (dealing) in the previous aggregated sessions>

As will be apparent to those skilled in the art, any format can be applied to the Agg Mobile IE in the signaling message. Further, the Agg Mobile IE can include, for example, list information composed of a list of the foregoing end-to-end sessions and related reservation information thereof. When the aggregator 115 inserts the Agg Mobile IE in the end-to-end signaling message, as shown in step 311, the aggregator 115 resets the corresponding mobility indicator.

After the aggregator 115 inserts the Agg Mobile IE in the end-to-end signaling message, as shown in step 313, the aggregator 115 modifies the end-to-end signaling message according to an aggregation request (for example, changes the IP protocol number). Specifically, such modification means, for example, to create a message flow passing an internal node of the domain 122 (passing transparently) according to the aggregation.

After step 313, the aggregator 115 checks whether or not new aggregated sessions are set up in the domain 122. If not, as shown in step 315, the aggregator 115 sets up the new aggregated sessions. The aggregator 115 can utilize the existing ART to set up new aggregated session paths in the domain 122.

When it is found that the end-to-end session is not part of the existing aggregated sessions in step 303, the aggregator 115 updates the new aggregated sessions or generates new aggregated sessions by a local policy or the like, as shown in step 305. After that, the aggregator 115 modifies the end-to-end signaling message similar to that shown in step 313, and, if necessary, the aggregator 115 updates the aggregated sessions, as shown in step 309.

In step 307, if the corresponding mobility indicator is not the appropriate value, the aggregator 115 executes step 309. After finishing step 309 or step 315, as shown in step 317, the aggregator 115 transmits the modified end-to-end signaling message to the deaggregator 117.

As shown in FIG. 2, such mobile modified end-to-end signaling messages (Mobile Mod E2E Sig Meg) 242, 252, 262 are not processed by the internal node in the domain 122, and directly reach the deaggregator 117.

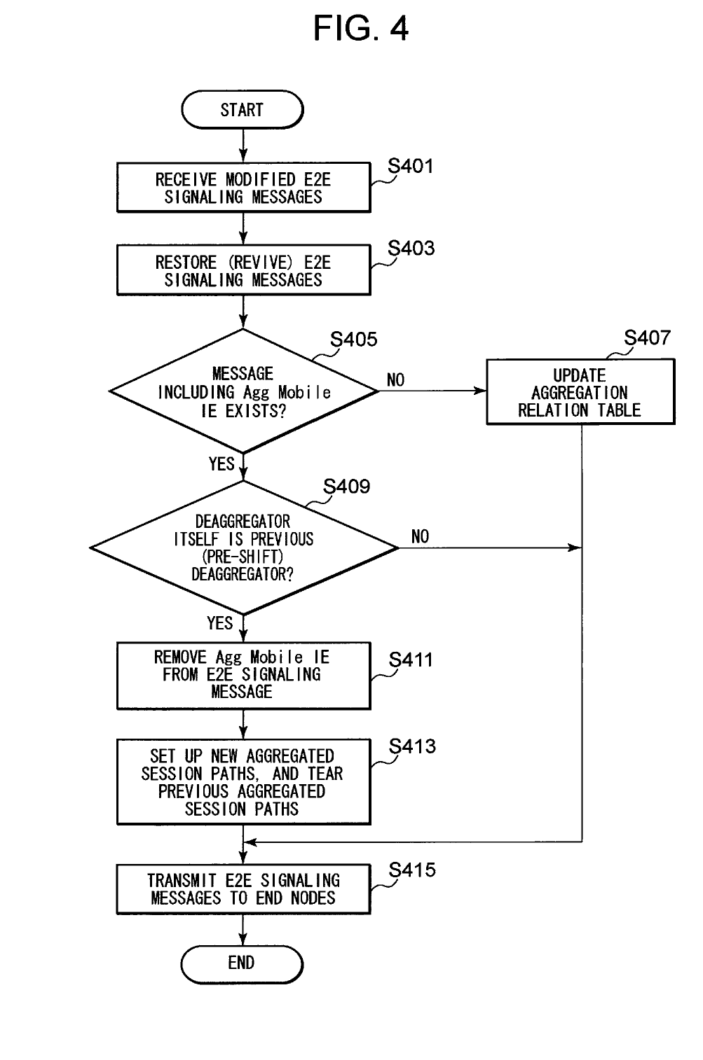

FIG. 4 shows an example of a processing procedure in the deaggregator 117 receiving the Mobile Mod E2E Sig Meg. As shown in FIG. 4, after the modified end-to-end signaling messages reach the deaggregator 117 in step 401 as shown in step 403, the deaggregator 117 restores (revives) the end-to-end signaling messages. This process is an opposite process of the process in step 313 or step 319 executed by the aggregator 115. In this process, for example, the IP protocol numbers in the messages are restored.

After that, as shown in step 405, the deaggregator 117 checks whether or not the message contains the Agg Mobile IE. When the message contains the Agg Mobile IE, it means that the aggregator 115 has changed the position. As shown in step 409, the deaggregator 117 checks whether or not the deaggregator 117 itself is a previous deaggregator indicated by the Agg Mobile IE.

When the deaggregator 117 is the previous deaggregator, the deaggregator 117 represents a crossover node between previous aggregated sessions and new aggregated sessions. The deaggregator 117 removes the Agg Mobile IE as in step 411, and executes management and update of the aggregated sessions. For example, as shown in step 413, the deaggregator 117 sets up new aggregated session paths, and tears previous aggregated session paths. This could be achieved in different manners depends on signaling scheme policies. For example, the deaggregator 117 could send messages to the effect of tearing the state from nodes along the old aggregated session path and send messages to the effect of establishing state on nodes along the new aggregated session path. Or, the deaggregator 117 could send a trigger message to the old aggregator 111 to initiate a tearing procedure from the aggregator 111. Meanwhile, in step 405, when the messages does not contain the Agg Mobile IE, the deaggregator 117 updates its aggregation relationship table, and executes after-mentioned step 415.

When it is found that the deaggregator 117 itself is not the previous deaggregator in step 409, it means that no crossover node exists in the new and the old aggregated sessions. In this case, the Agg Mobile IE is not removed from the end-to-end signaling messages. As shown in step 415, the end-to-end signaling messages are directly transmitted to end nodes. After finishing step 407 or 413, the deaggregator 117 executes step 415.

As shown in FIG. 2, end-to-end signaling messages (Mobile E2E Sig Msg) 243, 253, 263 having the Agg Mobile IE are transmitted to each corresponding end node along each end-to-end path. Since there are changes in the paths, some crossover nodes are generated. The crossover nodes are found by using, for example, the mechanism disclosed in non-patent document 2. As will be understood by those skilled in the art, the invention is processed by a certain crossover node finding mechanism.

When the crossover node (for example, CRN 131) receives the Mobile E2E Sig Msg 243, the crossover node recovers the Agg Mobile IE. For example, according to signalings in the non-patent document 2, some path updates are executed. Depends on the signaling scheme policies, different type of operations could be performed by the crossover node (for example, CRN131) For example, if the signaling scheme policy allows tearing of the old path from intermediary nodes, the CRN 131 could send a TEAR message (Mob Agg E2E Sig Msg 245) to a previous (old) path such as the deaggregator 113. Concurrently, the CRN 131 sends an update message 244 to the end node 141 by utilizing information of the received message. The CRN 131 adds the Agg Mobile IE obtained from the received Mobile E2E Sig Msg to the signaling message 245 sent to the previous path. The update message 244 could update the path towards ends node 141 in different manners depending on the signaling scheme policies. For example, it could replace the old state with the new state (with the aggregator at position 115). Alternatively, it could allow the old state to co-exist with the new state, e.g. combine the filter list (described in Non-patent document 4) of the states, and wait for the end node 141 to remove the old state.

If the signaling scheme policy requires tearing of old path to be initiated by the signaling ends or the crossover node does not have the privilege of tearing, the CRN 131 could send a NOTIFY message instead of TEAR (Mob Agg E2E Sig Msg 245) to a previous (old) path such as the deaggregator 113. Similarly, Agg Mobile IE obtained from the received Mobile E2E Sig Msg is added to the message 245. Update message 244 to the end node 141 will be issued by CRN 131.

Alternatively, the CRN 131 can just let the received Mobile E2E Sig Msg 243 pass as the update message 244 to the end node 141. Once the end node 141 receives such a message, it will issue the TEAR message along the old path such as the deaggregator 113, similar to that of Mob Agg E2E Sig Msg 245. The Agg Mobile IE should be included in the message 245 by the end node 141 in this case.

It is possible that the TEAR from the end node 141 may reach a node that no relevant state exists, e.g. the state has been removed by the crossover node, or removed by timeout. In such cases, the node could send an explicit notification back towards the end node 141 if a response is required by the TEAR, e.g. a RII exists in the TEAR message. Based on the notification, end node 141 will decide how to rectify the situation. Or the node receiving the TEAR could silently discard the message, and depends on the soft state management to correctly tear all the state on the old path if they are not already torn down. Yet another alternative is for the end node 141 to set a flag in the TEAR message, so that a node will forward the TEAR to the destination regardless if relevant state exists on it.

In certain case, the TEAR message has to be sent by the end node 141, e.g. when the state on the old path was established and owned by the end node 141. The end node 141 will issue a TEAR message towards the old path and a RESERVE towards the new path when necessary, e.g. detected a change in deaggregation point, or received a trigger from MN, CRN, or other nodes. It is obvious that the TEAR message from the end node 141 should also contain the aggregation information, e.g. Agg Mobile IE, so that the TEAR will trigger the deaggregation point to act accordingly.

It is possible that the end node 141 issue a combined TEAR and RESERVE message. In this case, when the CRN 131 receives this message, it should separate the two parts, and forward them accordingly (e.g. forward TEAR along the old path, and RESERVE along the new path). Any node that receives the combined message should process them accordingly, i.e. to tear state information about the old reservation and establishing state for the new reservation.

When the message 245 reaches the previous deaggregator (for example, deaggregator 113), tearing the previous aggregated sessions is started. For example, when the deaggregator 113 receives the TEAR or NOTIFY message, the deaggregator 113 checks presence of the Agg Mobile IE.

When the TEAR or NOTIFY message includes the Agg Mobile IE, the deaggregator 113 checks whether or not the previous deaggregator indicated by the Agg Mobile IE is the deaggregator itself, and checks whether or not previous aggregated sessions exist. When the results of the foregoing checks are confirmative, the deaggregator 113 can execute the desirable processing indicated in the aggregated sessions based on the Agg Mobile IE. For example, the deaggregator 113 can safely send a signaling message 232 to instantly tear the previous aggregated sessions. In result, reaction speed of aggregation session path management is largely improved.

As shown in FIG. 2, signaling messages 255, 265 from other each end-to-end session path reach the deaggregator 113. The previous aggregated session paths have been already removed. Therefore, the messages 255, 265 are ignored by the deaggregator 113, leading to decreased processing ability of the deaggregator 113. However, the messages 255, 256 improve reliability of this scheme. In some cases, some of the messages fail to reach the deaggregator 113. However, other messages assure removal of the previous aggregated sessions timely.

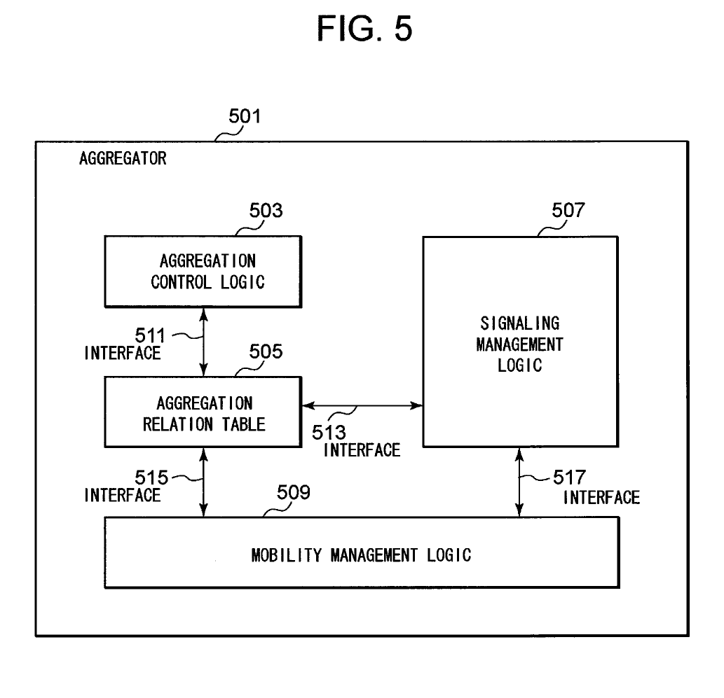

Here, a description will be hereinafter given of the foregoing aggregator and the foregoing deaggregator in detail. FIG. 5 shows an example of a structure of an aggregator 501. The structure is composed of 4 main regions. That is, the structure includes an aggregation control logic (ACL) 503 (corresponding to the foregoing aggregation control means), a signaling management logic (SML) 507 (corresponding to the foregoing signaling management means), a mobility management logic (MML) 509 (corresponding to the foregoing mobility management means), and an aggregation relationship table (ART) 505. The aggregation control logic 503 controls actual aggregation in data communication sessions. For example, control by the aggregation control logic 503 includes filtering a data packet, encapsulation by adding a new header to the packet if tunneling is necessary and the like.

Another essential element for the aggregator 501 is the aggregation relationship table 505. The aggregation relationship table 505 is a kind of a database of current end-to-end signaling messages and aggregated sessions. Further, the aggregation relationship table 505 accumulates information related to these sessions. As described above, there are some format examples of database entry. There is an interface 511 between the aggregation control logic 503 and the aggregation relationship table 505. The ACL 503 utilizes the interface 511 to access session aggregation information of the ART 505. Aggregation is performed according to the information recovered from the ART 505.

The signaling management logic 507 controls and processes received signaling messages. The aggregator logic (processing) shown in FIG. 3 is executed mainly by the SML 507. Further, the SML 507 recovers information from the ART 505 in processing the messages, and concurrently updates the ART 505. Recovery and update of the information in the ART 505 are executed via the interface 513.

As a still another element to affect aggregation processing, there is the mobility management logic 509. The MML 509 maintains a trace of a mobility status of the aggregator 501, updates corresponding sections of the ART 505 via the interface 515, and generates signaling actions from the SML 507 via the interface 517. For example, when the SML 507 detects a mobility event in the aggregator 501, the MML 509 can update entries of the ART 505, and, for example, appropriately sets all mobility indicators of the entries existing in the ART 505.

In a mobile communication network, the aggregator becomes a communication end node most of the time. For example, a mobile terminal in interconnection of a wireless LAN should structure a tunneling in a packet data gateway (PDG) to access services. Therefore, a plurality of sessions on the mobile terminal are aggregated, and a deaggregator becomes the PDG. The invention can be applied to such a case, since in the invention, signalings can be started immediately after the aggregator is shifted. In this case, the messages 241, 251, 261 shown in FIG. 2 become unnecessary. In this case, it is evident that the MML 509 can start corresponding end-to-end signalings executed by the SML 507 via the interface 517.

In the case that where the aggregator 501 and communication ends are arranged is not known, when the SML 507 receives a trigger from the MML 509 via the interface 517, the SML 507 has 2 methods of promoting (accelerating) signalings. One method is as follows. The SML 507 sends Notification messages to singling nodes (for example, the signaling nodes 101 to 105) respectively. Accordingly, end-to-end signaling messages are instantly sent from the signaling nodes (for example, the signaling nodes 101 to 105). The other method is as follows. Before trigger to each session, the SML 507 resends the end-to-end signaling messages lastly received. The procedure by this method can be started without waiting next messages from the signaling nodes 101 to 105.

In a certain case, the aggregator 111 and the aggregator 115 are different nodes. For example, in a personal area network or a mobile network, the aggregator 111 and the aggregator 115 can become 2 mobile routers capable of being utilized by using different access technologies. At a certain point, an internal node of the network determines that one mobile router is switched to another mobile router according to the network state. In such a case, the ACL (503) or the aggregator 111 and the aggregator 115 communicate by using a local means with which the ART can be directly shifted from the initial aggregator to a new aggregator. As will be understood by those skilled in the art, the invention can efficiently manage aggregation.

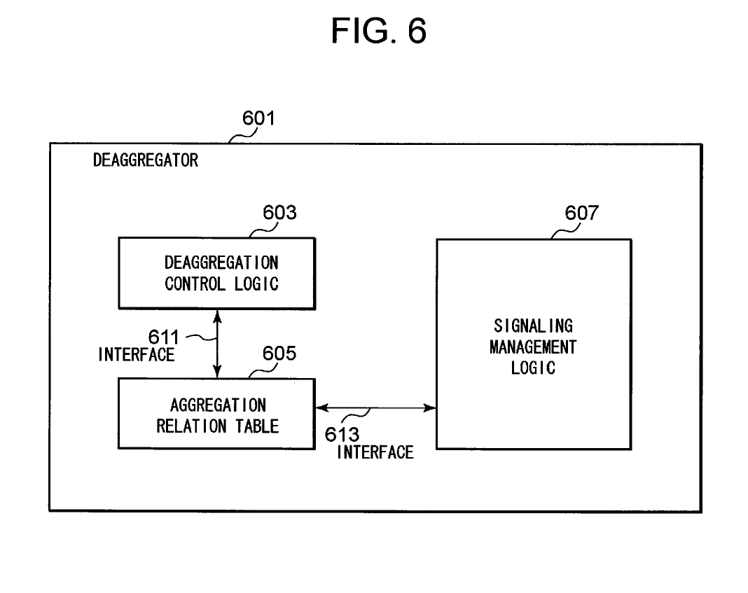

FIG. 6 shows an example of a structure of a deaggregator 601. The structure is composed of 3 main regions. That is, the structure includes a deaggregation control logic (DCL) 603 (corresponding to the foregoing deaggregation control means), an aggregation relationship table (ART) 605, and a signaling management logic (SML) 607 (corresponding to the foregoing signaling management means). The DCL 603 manages deaggregation processing of data traffics, and for example, removes excess header information inserted by the aggregator 501. Such deaggregation operations are executed based on information on aggregated sessions accumulated in the ART 605. Here, the ART 605 has a format and a structure similar to those of the ART 505 of the aggregator 501. The DCL 603 accesses the information in the ART 605 via an interface 611. The SML 607 processes received signaling messages by using the logic described in FIG. 4. Further, the SML 607 utilizes the information in the ART 605, and updates the information if necessary when, for example, receiving a TEAR message. Such operations are executed via an interface 613.

The embodiment of the invention has been described. Each functional block used for describing the foregoing embodiment is typically realized as an LSI as an integrated circuit. Each functional block may be composed of 1 chip individually, or part or all thereof may be composed of 1 chip. The LSI may be also called an IC, a system LSI, a super LSI, or an ultra LSI according to the integration degree. A method of creating the integrated circuit is not limited to the LSI, but an exclusive circuit or a general purpose processor may be utilized. It is possible to utilize an FPGA (Field Programmable Gate Array) programmable after manufacturing the LSI or a reconfigurable processor capable of restructuring connections and settings of a circuit cell in the LSI. Further, if an integrated circuit technology replacing the LSI is introduced by progress of the semiconductor technology or derived separate technologies, it is needless to say that the functional block may be integrated by using such a technology. For example, applying the bio technology has a potential. The invention herein disclosed and described is taken as the most practical and the most preferable embodiment. However, the invention is not limited to the described details as long as within the scope of the invention. Thus, the scope of claims includes all devices, apparatuses and the like.

### INDUSTRIAL APPLICABILITY

The aggregation management system, the aggregate node, and the deaggregate node according to the invention can quickly and efficiently manage aggregation in a mobile environment. Therefore, the aggregation management system, the aggregate node, and the deaggregate node according to the invention can be used as an aggregation management system, an aggregate node, a deaggregate node and the like which relate to a data communication network, and in particular, perform signalings in a packet based on a data communication system having aggregated sessions and resource management.

1. An aggregation management system in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node, wherein
after a position of aggregator in first aggregated session is shifted from the region of the first aggregated session,
the aggregate node adds mobile status information indicating its mobile status to a signaling message in the end-to-end signaling session received from the mobile terminal, and sends the signaling message added with the mobile status information to a deaggregate node in second aggregated session where the position of the aggregator is shifted,
the deaggregate node in the second aggregated session (or the relay node as a crossover node which is a branch point between old and new paths) which receives the signaling message added with the mobile status information, based on the mobile status information, releases the first aggregated session, or sends a message to release the first aggregated session to a deaggregate node in the first aggregated session.

2. The aggregation management system according to claim 1, wherein the mobile status information is composed of information indicating that the position of the aggregator is shifted and information on the first aggregated session.

3. The aggregation management system according to claim 2, wherein the mobile status information further includes information on the deaggregate node in the first aggregated session.

4. The aggregation management system according to claim 2, wherein the mobile status information further includes information on dealing with the first aggregated session.

5. The aggregation management system according to claim 1, wherein the aggregate node retains an aggregation relationship table indicating a relationship between the one or more end-to-end signaling sessions and the aggregated sessions.

6. The aggregation management system according to claim 1, wherein the aggregate node further includes a means for recognizing a relation between shift of the position of the aggregator and receiving signaling messages in the one or more end-to-end signaling sessions.

7. The aggregation management system according to claim 1, wherein the relay node receiving the signaling message with the mobile status information adds information on dealing of the first aggregated session to the message for releasing the first aggregated session which is sent when the relay node is the crossover node based on the mobile status information.

8. The aggregation management system according to claim 1, wherein the deaggregate node in the first aggregated session releases the first aggregated sessions, based on the message for releasing the first aggregated session.

9. The aggregation management system according to claim 1, wherein the aggregate node is one of ends of the one or more end-to-end signaling sessions.

10. The aggregation management system according to claim 1, wherein the aggregate node is a mobile router in a mobile network.

11. The aggregation management system according to claim 1, wherein the aggregate node is one node in a personal area network.

12. The aggregation management system according to claim 1, wherein the aggregate node notifies shift of the position of the aggregator to end nodes of the one or more end-to-end signaling sessions.

13. The aggregation management system according to claim 1, wherein the aggregate node resends one or more of the signaling messages in the one or more end-to-end signaling sessions which are received before shift of the position of the aggregator.

14. An aggregate node in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node comprising:
an aggregation control means for performing session aggregation;
an aggregation relationship table for storing information on the one or more end-to-end signaling sessions and the aggregated sessions;
a signaling management means for processing and transmitting a received end-to-end signaling message and a signaling message of the aggregated sessions; and
a mobility management means for maintaining a trace of an aggregate node status, updating the aggregation relationship table, and sending a trigger to the signaling management means.

15. A deaggregate node in a communication network in which a mobile terminal and a communication other party node as a communication other party of the mobile terminal communicate through a region of aggregated sessions obtained by aggregating end-to-end signaling sessions between the mobile terminal and the communication other party node by an aggregate node, the aggregate node and a deaggregate node are located on edges of the region of the aggregated sessions, and a relay node relaying a signaling message is further provided between the deaggregate node and the communication other party node comprising:
a deaggregation control means for performing session deaggregation;
an aggregation relationship table for storing information on the one or more end-to-end signaling sessions and the aggregated sessions; and
a signaling management means for processing and transmitting a received end-to-end signaling message and a signaling message of the aggregated sessions, wherein
the signaling management means updates the aggregation relationship table according to the received signaling message, and
the deaggregation control means performs session deaggregation according to the information stored in the aggregation relationship table.

16. The aggregation management system according to claim 3, wherein the mobile status information further includes information on dealing with the first aggregated session.
